(19) United States
(12) Patent Application Publication
(10) Pub. No.: US 2003/0014563 A1
(43) Pub. Date: Jan. 16, 2003

(54) Adding functionality to functions inside a dynamic-link library (DLL) without recompiling it

(76) Inventor: John Mark Whitaker, Markham (CA)

Correspondence Address: FINNEGAN, HENDERSON, FARABOW, GARRETT &, DUNNER LLP, 1300 I STREET, NW, WASHINGTON, DC, 20006, US

(21) Appl. No.: 09/903,593

(22) Filed: Jul. 13, 2001

(51) Int. Cl. G06F 9/00

(52) U.S. Cl. 709/331

(57) ABSTRACT

The present invention provides a method and apparatus for adding functionality to a software module, associated with an application program. The software module includes a plurality of object files, each having at least one instruction set to define at least one computer routine. The method includes the steps of extracting an object file from the software module and removing the object file from the software module an object file for modification and placing a new instruction set having additional functionality into software module.

### FIELD OF THE INVENTION

The present invention relates to computer programming, more particularly it relates to a method and system for adding functionality to a function in a DLL library.

### BACKGROUND OF THE INVENTION

A computer application program usually includes a number of separate routines, which include a main program and several subsidiary routines referred to as objects, modules, or resources. Typically, execution of the application program begins with the main program with calls being made to the subsidiary routines.

To operate as a complete program, prior to execution these routines are linked together using a linker such as 386 link. The linker copies each of the routines into an executable file for the application program. The linker also provides each of the routines with information identifying the locations of other routines so that the routines can access each other. The executable file can then be loaded into-the memory of a computer such that the computer can execute the application program according to the instructions in the routines.

A dynamic link library (DLL) is an executable module or routine containing services that application programs can call to perform useful tasks, for example login commands, character string manipulations, and so forth. DLLs exist primarily to provide services to application programs. These libraries play an important role in operating systems such as Windows, which use them to make their services and resources available to application programs. Application programs that use code from DLLs share that code with other application programs using the DLL, therefore reducing the application size.

DLLs are linked with the application program at run time, that is, when the computer is executing the application program, not when the application program files are linked with the linker.

Typically, a DLL may be modified to provide added functionality by examining the source code to change the instruction sets or functions within the DLL. However, it may be infeasible to examine code on certain platforms as the code may be hardwired or protected as a trade secret or simply unavailable to diminish the chances of reverse engineering.

### SUMMARY OF THE INVENTION

In one of its aspects, the present invention provides a method and system for adding functionality to a software module, associated with an application program. The software module includes a plurality of object files, each having at least one instruction set to define at least one computer routine. The method includes the following steps, the first of which includes extracting an object file from the software module and removing the object file from the software module. The next step includes modifying all occurrences of an instruction set associated with a first name in the software module by associating the at least one instruction set with a second name, and adding the at least one instruction set associated with the second name into the software module. After which, a new instruction set is written and the new instruction set having additional functionality is associated with the first name. The final step involves placing the new instruction set associated with the first name in the software module, such that the new instruction set may call the at least one instruction set associated with the second name when desired.

### BRIEF DESCRIPTION OF THE DRAWINGS

These and other features of the preferred embodiments of the invention will become more apparent in the following detailed description in which reference is made to the appended drawings wherein:

FIG. 1 shows a system overview for the implementing a method of the present invention; and

FIG. 2 show a flow chart outlining the steps for adding functionality to a software module.

### DETAILED DESCRIPTION OF THE INVENTION

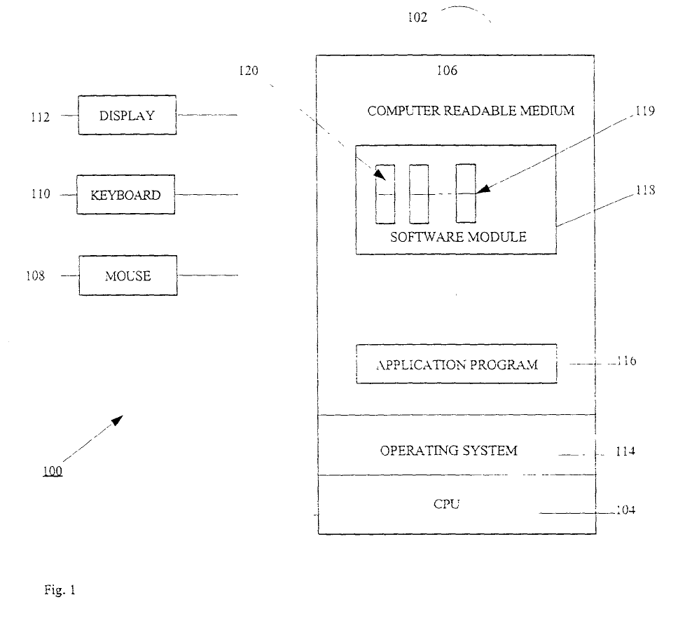

Reference is first made to FIG. 1 which shows an overview of a system for implementing a method of adding functionality to a software module, shown generally by numeral 100, in a preferred embodiment. A computer 102 includes a processor 104, a computer readable medium 106 including ROM, flash memory, non-volatile RAM, magnetic disk, optical disk, IC memory card, magnetic tape. The computer also includes input and output devices such as a mouse 108, a keyboard 110 and a display 112. The computer 102 executes a conventional operating system 114, such as Microsoft Windows 2000® or UNIX. Alternatively, the computer 102 may be a handheld computing device with a handheld operating system such as EPOC, Palm®OS or Pocket PC®OS. Such handheld devices may include personal digital assistants (PDAs), pagers, cellphones and other wireless information devices.

The computer readable medium 106 includes the operating system which as Palm OS, Pocket PC or EPOC. Also included is at least one application program 116 such as an email client, for example Microsoft Outlook, which uses a messaging application programming interface (MAPI) DLL to provide email capability in WINDOWS, such that any other application that needs to include an email interface uses MAPI to do it. The application program 116 is executed by the computer 102 according to software modules 118 having object files 119 associated with at least one instruction set 120. The application program 116 typically includes a plurality of distinct software modules 118 that may include a main program and other subsidiary instruction sets.

A software module 118 such as a DLL, is an executable instruction set that may contain services than an application program 116 may call to perform tasks such as character string manipulations or login commands. Other software modules may include OLE Custom control (OCX), Drivers (DRV) or Virtual Device Drivers (VXD) which may be implemented in DLLs.

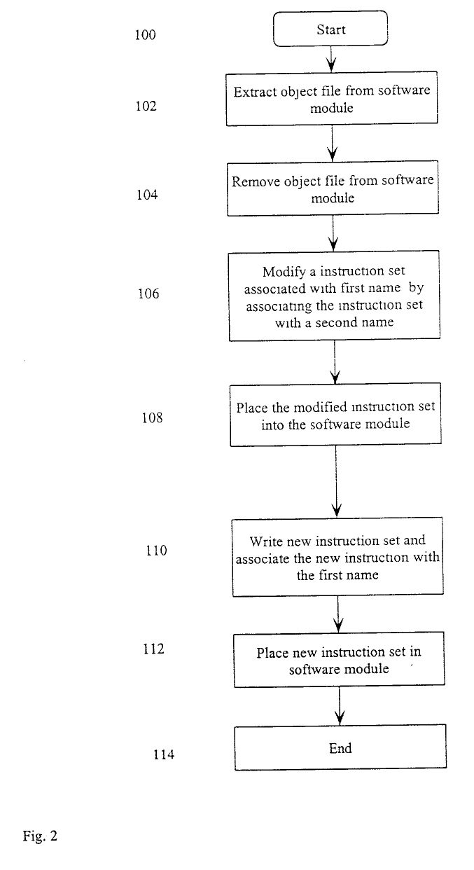

A DLL 118 can be modified to provide added functionality by examining the source code to change the instruction sets 120 or functions within the DLL 118, after which the DLL is recompiled to translate the source code into machine language. However, as mentioned above, it may be infeasible to examine code on certain platforms, as the code may be unavailable to diminish the chances of reverse engineering. In such instances, however, the DLL 118 may be modified by a process, as shown in FIG. 2, to add functionality to the DLL 118 without recompiling it includes the steps of extracting an object file 120 from the software module 118 and removing the object file 119 from the software module 118. The next step includes modifying all occurrences of at least one instruction set 120 associated with a first name in the software module 118 by associating the at least one instruction set 120 with a second name, and adding the at least one instruction 120 set associated with the second name into the software module 118, writing a new instruction set and associating the new instruction set having additional functionality with the first name, and placing the new instruction set associated with the first name in the software module, such that the new instruction set may call the at least one instruction set associated with the second name when desired.

The new instruction set 120 contains additional functionality and the at least one instruction set 120 associated with the second name may need not be called if at least one instruction set 120 associated with the second name is not required. Preferably, the new instruction set 120 may include all of the functions of the at least one instruction set 120 associated with the second name and the new functions from step 110. Also, the second name and the first name are related to each other by having the lengths of the first name and the second name the same.

Further, the number of arguments and their corresponding types in the new instruction set 120 match those of the instruction set associated with the first name for operability.

The above-described embodiments of the invention are intended to be examples of the present invention and alterations and modifications may be effected thereto, by those of skill in the art, without departing from the scope of the invention which is defined solely by the claims appended hereto.

The embodiments of the invention in which an exclusive property or privilege is claimed are defined as follows:

1. A method for adding functionality to a software module associated with an application program, said software module having a plurality of object files associated with a at least one instruction set, the method including the steps of:
(a) extracting an object file from said software module;
(b) removing said object file from said software module;
(b) modifying all occurrences of at least one instruction set associated with a first name in said software module by associating said at least one instruction set with a second name;
(c) adding said at least one instruction set associated with said second name into said software module;
(d) writing a new instruction set having additional functionality and associating said new instruction set with said first name; and
(e) placing said new instruction set associated with said first name in said software module for execution by said application program.

2. The method of claim 1, wherein said software module is a dynamic link library (DLL), an OLE custom control (OCX), a driver (DRV), and a virtual device driver (VXD).

3. The method of claim 1, wherein the step of execution includes a further step of calling said at least one instruction set associated with said second name.

4. The method of claim 1, wherein said first name and second name have the same size.

5. The method of claim 1, wherein said preferably new instruction set includes a plurality of arguments and corresponding types equal in number to a plurality of arguments and corresponding types included in said the instruction set associated with the first name.

6. The method of claim 1, wherein the step of writing a new instruction set having additional functionality includes having the instruction set associated with said second name in said new instruction set.

7. The method of claim 6, wherein said the step of execution excludes a further step of calling said at least one instruction set associated with said second name.

8. The method of claim 1, wherein the step adding functionality to a software module excludes a further step of recompiling the software module.

9. A system for adding functionality to a software module, said system having a computer readable medium for storing said a software module associated with an application program, said software module having a plurality of object files associated with at least one instruction set, said system having:
an object file removable from said software module for modification of all occurrences of at least one instruction set associated with a first name in said software module by associating said at least one instruction set with a second name and said modified object file insertable into said software module after modification; and
a new instruction set having additional functionality and associated with said first name and insertable into said software module.

10. The computer readable medium of claim 9, wherein said new instruction set associated with said first name includes instruction set with said second name.

11. The computer readable medium of claim 9, the software module is a dynamic link library, an OLE custom control, a driver (DRV) or a VXD.
